(19) United States
(12) Patent Application Publication
(10) Pub. No.: US 2026/0238284 A1
(43) Pub. Date: Aug. 13, 2026

(54) REFERENCE SIGNAL CONFIGURATION FOR MULTI-TRANSMIT-RECEIVE POINT COHERENT JOINT TRANSMISSION

(71) Applicant: Apple Inc., Cupertino, CA (US)

(72) Inventors: Haitong Sun, Saratoga, CA (US); Dan Wu, Beijing (CN); Wei Zeng, Saratoga, CA (US); Chunxuan Ye, San Diego, CA (US); Dawei Zhang, Saratoga, CA (US)

(73) Assignee: Apple Inc., Cupertino, CA (US)

(21) Appl. No.: 19/157,267

(22) PCT Filed: Feb. 16, 2023
(86) PCT No.: PCT/CN2023/076376

§ 371 Date: Aug. 15, 2025

(51) Int. Cl. H04B 7/06; H04W 52/10; H04W 76/28

(52) U.S. Cl. CPC H04B 7/0626; H04B 7/06968; H04W 52/10; H04W 76/28

(57) ABSTRACT

The present application relates to devices and components including apparatus, systems, and methods for reference signal configuration for multi-transmit-receive point coherent joint transmission in wireless networks.

### TECHNICAL FIELD

This application relates generally to communication networks and, in particular, to technologies for reference signal configuration for multi-transmit-receive point (mTRP) coherent joint transmission in wireless networks.

### BACKGROUND

Third Generation Partnership Project (3GPP) Releases 15, 16, and 17 provide support for advanced channel state information (CSI) reporting by exploiting channel correlations. In Release 15, Type II multi-input, multi-output (MIMO) codebook and Type II port selection is specified based on spatial basis selection and a combination coefficient. In Release 16, enhanced Type II MIMO codebook and Type II port selection codebook is specified based on the spatial basis selection, the combination coefficient, and a frequency basis selection. In Release 17, further enhanced Type II port selection codebooks are specified.

### BRIEF DESCRIPTION OF THE DRAWINGS

FIG. 1 illustrates a network environment in accordance with some embodiments.

FIG. 2 illustrates a resource set in accordance with some embodiments.

FIG. 3 illustrates signaling diagrams in accordance with some embodiments.

FIG. 4 illustrates resource mapping in accordance with some embodiments.

FIG. 5 illustrates another resource mapping in accordance with some embodiments.

FIG. 6 illustrates an operational flow/algorithmic structure in accordance with some embodiments.

FIG. 7 illustrates another operational flow/algorithmic structure in accordance with some embodiments.

FIG. 8 illustrates another operational flow/algorithmic structure in accordance with some embodiments.

FIG. 9 illustrates a user equipment in accordance with some embodiments.

FIG. 10 illustrates a network node in accordance with some embodiments.

### DETAILED DESCRIPTION

The following detailed description refers to the accompanying drawings. The same reference numbers may be used in different drawings to identify the same or similar elements. In the following description, for purposes of explanation and not limitation, specific details are set forth, such as particular structures, architectures, interfaces, and/or techniques in order to provide a thorough understanding of the various aspects of some embodiments. However, it will be apparent to those skilled in the art having the benefit of the present disclosure that the various aspects of the various aspects may be practiced in other examples that depart from these specific details. In certain instances, descriptions of well-known devices, circuits, and methods are omitted so as not to obscure the description of the various aspects with unnecessary detail. For the purposes of the present document, the phrase “A or B” means (A), (B), or (A and B); and the phrase “based on A” means “based at least in part on A,” for example, it could be “based solely on A” or it could be “based in part on A.”

The following is a glossary of terms that may be used in this disclosure.

The term “circuitry” as used herein refers to, is part of, or includes hardware components, such as an electronic circuit, a logic circuit, a processor (shared, dedicated, or group) or memory (shared, dedicated, or group), an application specific integrated circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable system-on-a-chip (SoC)), and/or digital signal processors (DSPs), that are configured to provide the described functionality. In some aspects, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these aspects, the combination of hardware elements and program code may be referred to as a particular type of circuitry.

The term “processor circuitry” as used herein refers to, is part of, or includes circuitry capable of sequentially and automatically carrying out a sequence of arithmetic or logical operations; or recording, storing, or transferring digital data. The term “processor circuitry” may refer an application processor; baseband processor; a central processing unit (CPU); a graphics processing unit; a single-core processor; a dual-core processor; a triple-core processor; a quad-core processor; or any other device capable of executing or otherwise operating computer-executable instructions, such as program code; software modules; or functional processes.

The term “interface circuitry” as used herein refers to, is part of, or includes circuitry that enables the exchange of information between two or more components or devices. The term “interface circuitry” may refer to one or more hardware interfaces; for example, buses, I/O interfaces, peripheral component interfaces, network interface cards, or the like.

The term “user equipment” or “UE” as used herein refers to a device with radio communication capabilities and may describe a remote user of network resources in a communications network. The term “user equipment” or “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, reconfigurable mobile device, etc. Furthermore, the term “user equipment” or “UE” may include any type of wireless/wired device or any computing device including a wireless communications interface.

The term “computer system” as used herein refers to any type of interconnected electronic devices, computer devices, or components thereof. Additionally, the term “computer system” or “system” may refer to various components of a computer that are communicatively coupled with one another. Furthermore, the term “computer system” or “system” may refer to multiple computer devices or multiple computing systems that are communicatively coupled with one another and configured to share computing or networking resources.

The term “resource” as used herein refers to a physical or virtual device, a physical or virtual component within a computing environment, or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, workload units, or the like. A “hardware resource” may refer to computer, storage, or network resources provided by physical hardware element(s). A “virtualized resource” may refer to computer, storage, or network resources provided by virtualization infrastructure to an application, device, system, etc. The term “network resource” or “communication resource” may refer to resources that are accessible by computer devices/systems via a communications network. The term “system resources” may refer to any kind of shared entities to provide services and may include computing or network resources. System resources may be considered as a set of coherent functions, network data objects or services, accessible through a server where such system resources reside on a single host or multiple hosts and are clearly identifiable.

The term “channel” as used herein refers to any transmission medium, either tangible or intangible, which is used to communicate data or a data stream. The term “channel” may be synonymous with or equivalent to “communications channel,” “data communications channel,” “transmission channel,” “data transmission channel,” “access channel,” “data access channel,” “link,” “data link,” “carrier,” “radio-frequency carrier,” or any other like term denoting a pathway or medium through which data is communicated.

Additionally, the term “link” as used herein refers to a connection between two devices for the purpose of transmitting and receiving information.

The terms “instantiate,” “instantiation,” and the like as used herein refers to the creation of an instance. An “instance” also refers to a concrete occurrence of an object, which may occur, for example, during execution of program code.

The term “connected” may mean that two or more elements, at a common communication protocol layer, have an established signaling relationship with one another over a communication channel, link, interface, or reference point.

The term “network element” as used herein refers to physical or virtualized equipment or infrastructure used to provide wired or wireless communication network services. The term “network element” may be considered synonymous to or referred to as a networked computer, networking hardware, network equipment, network node, virtualized network function, or the like.

The term “information element” refers to a structural element containing one or more fields. The term “field” refers to individual contents of an information element or a data element that contains content. An information element may include one or more additional information elements.

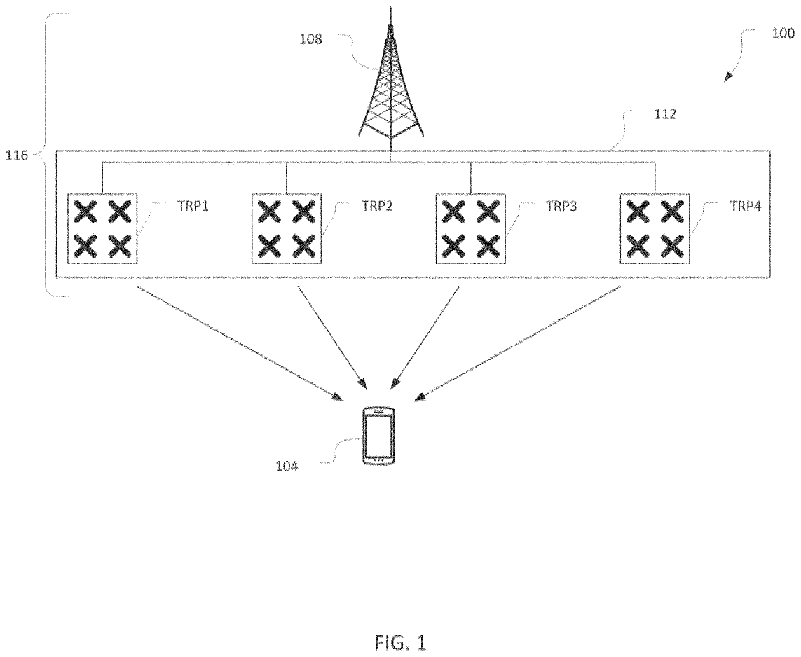

FIG. 1 illustrates a network environment 100 in accordance with some embodiments. The network environment 100 may include a UE 104 and a base station 108.

The base station 108 may be coupled with a plurality of transmit-receive points (TRPs) 112 to provide one or more wireless access cells through which the UE 104 may communicate.

As shown, the base station 108 may be coupled with four TRPs 112, e.g., TRP1, TRP2, TRP3, and TRP4. The base station 108 may use the TRPs 112 to provide geographically distributed points of transmission/reception to increase cell coverage and spatial diversity. Each of the TRPs may include a single TRP or a group of TRPs that are generally controlled as a single TRP.

While FIG. 1 illustrates the base station 108 coupled with the four TRPs directly, in other embodiments, more than one base station may be coupled with the four TRPs and the base stations may communicate with one other over a backhaul link to coordinate communications with the UE 104. The base station 108 and TRPs 112 may be collectively referred to as an access node 116.

The access node 116 may provide an air interface compatible with 3GPP technical specifications, such as those that define Fifth Generation (5G) new radio (NR) or later system standards. Depending on the technology, the base station 108 may be referred to as an eNB, gNB, an ng-NB, etc. The access node 116 may provide the UE 104 access to other networks, for example, a core network, a data network, etc.

The access node 116 may be capable of performing a coherent joint transmission (CJT) by jointly precoding downlink transmissions in a coherent manner such that transmissions from the different TRPs 112 are phase-aligned. CJT may be enabled by the TRPs 112 having desired synchronization in both time and frequency provided by high-speed connections over backhaul links of the access node 116. For discussion herein, the number of TRPs the may be involved in a CJT may be referred to as N_{TRP}, which is an integer greater than one and, in some instances, less than five. Each of the TRPs 112 may be configured with a same number of antenna ports for the mTRP CJT.

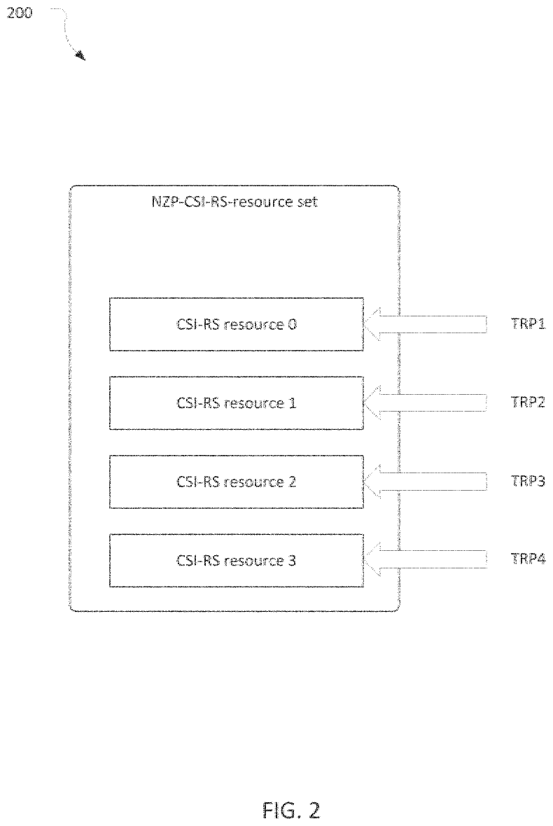

In some embodiments, the Type II codebook may be refined and associated channel state information (CSI) reporting may be defined to facilitate CJT by the N_{TRP} TRPs 112. For example, a channel measurement resource (CMR) may be defined that includes a nonzero power (NZP)-CSI-RS-Resource Set 200 as shown in FIG. 2 in accordance with some embodiments. The NZP-CSI-RS-Resource Set 200 may include K CSI-RS resources, where K is an integer greater than one. As shown, the NZP-CSI-RS-resource set 200 may include four NZP-CSI-RS resources, e.g., NZP-CSI-RS resource 0, NZP-CSI-RS resource 1, NZP-CSI-RS resource 2, and NZP-CSI-RS resource 3. In some embodiments, K=N_{TRP} with each NZP-CSI-RS resource corresponding to a respective TRP. Thus, TRP1 may transmit a NZP-CSI RS using NZP-CSI-RS resource 0, TRP2 may transmit a NZP-CSI RS using NZP-CSI-RS resource 1, etc. Each of the NZP-CSI-RS resources may have a same number of CSI-RS ports. For example, as shown in FIG. 1, each of the four TRPs may use 8 ports (four ports corresponding to four vertical-polarized antenna elements and four ports corresponding to four horizontal-polarized antenna elements) for transmitting a respective NZP-CSI RS. Thus, an mTRP CJT may be capable of using 32 ports (e.g., antenna elements) spread over the four TRPs. In other embodiments, the TRPs may each include, for example, 16 ports or 32 ports.

In general, the UE 104 may use the configuration of the NZP-CSI-RS-resource set to receive and measure NZP-CSI RSs transmitted by the access node 116. The UE 104 may generate CSI based on these measurements. The CSI may include, for example, a channel quality indicator (CQI), a rank indicator (RI), and a precoding matrix indicator (PMI). The CSI may then be reported back to the access node 116.

Embodiments of the present disclosure provide details for reference signal configuration to support mTRP CJT CSI feedback. Some details describe CMR configuration, CSI-RS resource indicator (CRI), and interference measurement resource (IMR) configuration.

The CMR configuration may be provided by radio resource control (RRC) signaling of various combinations of NZP-CSI-RS-Resource configurations and NZP-CSI-RS-ResourceSet configurations. Aspects of the CMR configuration to support mTRP CJT may be described as follows.

In a first aspect, the CMR configuration for mTRP CJT across NTRP NZP-CSI-RS resources may be limited in the total number of antenna ports that may be used. This may be due, in part, to limitations on processing capabilities of the UE 104. For example, each TRP may be capable of transmitting across 32 ports. If the UE 104 is capable of receiving by four ports, (32 tx ports*4 rx ports*4 TRPs=) 512 channels may need to be measured for a 4-TRP CJT. The UE 104 would likely not have sufficient processing capabilities to perform these measurements in a timely manner. Thus, in some embodiments, for CMR configuration for mTRP CJT across N_{TRP} NZP-CSI-RS resources, a maximum total number of antenna ports may be limited by, for example, a 3GPP TS. In some embodiments, the maximum number of antenna ports may be limited to 32 or 64. As discussed above, the number of antenna ports used by each TRP may be the same, thus, a maximum number of 32 antenna ports would result in each of the four TRPs 112 transmitting NZP-CSI-RS on eight antenna ports. Similarly, a maximum number of 64 antenna ports would result in each of the four TRPs 112 transmitting an NZP-CSI-RS on 16 antenna ports.

In another aspect of the description, the UE 104 may transmit a CMR processing capability to the access node 116 to facilitate CSI reporting for mTRP CJT. This CMR processing capability may serve as a basis for the access node 116 generating a CMR configuration.

The CMR processing capability may include information relevant to the number of resources or ports the UE is capable of measuring for CSI. In some embodiments, the CMR processing capability may include one or more triplets. Each triplet may include three elements. A first element may be a maximum total number of NZP-CSI-RS Resources the UE can simultaneously process across all component carriers (CCs). A second element may be a maximum total number of NZP-CSI-RS ports the UE can simultaneously process across all CCs. And a third element may be a maximum number of NZP-CSI-RS ports that the UE can process.

The third element of the triplet, the maximum number of NZP-CSI-RS ports that the UE can process, may have one of the following definitions. In a first definition, the number may refer to the maximum number of NZP-CSI-RS ports in a NZP-CSI-RS resource. In a second definition, the number may refer to the maximum number of NZP-CSI-RS ports across the N_{TRP} NZP-CSI-RS resources.

As can be seen, the elements of the triplets may have an interdependence with one another. For example, if a UE indicates support for a large number of ports per resource (e.g., first definition of the third element), it may need to report that it handles a relatively lower number of overall resources supported (e.g., the first element). Thus, the list of triplets may provide a number of specific combinations that are supported by the UE 104. The access node 116 may then select one of these supported combinations for the CMR configuration.

In another aspect of the description, the CMR configuration may include one or more of the following information elements (IEs) for mTRP CJT across N_{TRP} NZP-CSI-RS resources.

In some embodiment, the CMR configuration may include an IE with a power control offset (powerControlOffset) value that is to be used for CQI calculation. The powerControlOffset value provides an assumed ratio of a physical downlink shared channel (PDSCH) energy per resource element (EPRE) to the NZP-CSI-RS EPRE. The UE 104 may use this assumed ratio to calculate the CQI of the CSI. In some embodiments, the powerControlOffset value may be in the range of [−8, 15] dB with 1 dB step sizes.

In some embodiments, the CMR configuration may include an IE with a power control offset synchronization signal (powerControlOffsetSS) value that is to be used for power control (e.g., open-loop power control). The powerControlOffsetSS value provides an assumed ratio of an NZP-CSI-RS EPRE to synchronization signal/physical broadcast channel (SS/PBCH) block EPRE.

In some embodiments, the CMR configuration may include an IE with a periodicity and offset (periodicityAndOffset) value used to configure a time-domain pattern (e.g., a periodicity and slot offset) of a periodic NZP-CSI RS.

In some embodiments, one or more of these IEs may provide the same value for each of the N_{TRP} NZP-CSI-RS resources of the NZP-CSI-RS-Resource set. For example, the same powerControlOffset value may be configured for each of the N_{TRP} NZP-CSI-RS resources. Providing the same powerControlOffset value may facilitate calculation of the CQI that may be used to define the channel of the mTRP CJT. In some embodiments, the values of powerControlOffsetSS or periodicity AndOffset may be held constant for each of the N_{TRP} NZP-CSI-RS resources.

In some embodiments, these IEs may be in separate resource configurations (e.g., NZP-CSI-RS-Resource configuration), with the constant value being a limitation on which resource configurations may be included into a particular resource set configuration (e.g., NZP-CSI-RS-ResourceSet configuration). In other embodiments, common values for resources of a resource set may be provided separately in the resource set configuration.

In some embodiments, the CMR configuration may include different powerControlOffset values configured for different resources of the N_{TRP} NZP-CSI-RS resources of the NZP-CSI-RS-Resource set. In these embodiments, the CQI calculation may be accomplished by one or more of the following options.

In a first option, an average powerControlOffset value across the N_{TRP} NZP-CSI-RS resources may be calculated and used for determining the CQI for the N_{TRP} NZP-CSI-RS resources. Thus, one powerControlOffset value may be used to determine the CQI that is included in the CSI report.

In a second option, each powerControlOffset value may be applied to a respective TRP/NZP-CSI-RS resource. With this option, the UE may calculate N_{TRP} CQIs that respectively correspond to the N_{TRP} NZP-CSI-RS resources, or the UE may calculate a single QCI assuming a transport block carried by PDSCH is transmitted jointly and coherently from N_{TRP} TRPs.

In some embodiments, the CMR configuration may account for time-domain constraints desired for transmitting the NZP-CSI-RSs. In particular, it may be desirable for all NZP-CSI-RSs to be transmitted within a certain period of time. This may avoid requiring the UE 104 to buffer measurements for a long period of time and may also help to ensure the constituent channels are measured at approximately the same time.

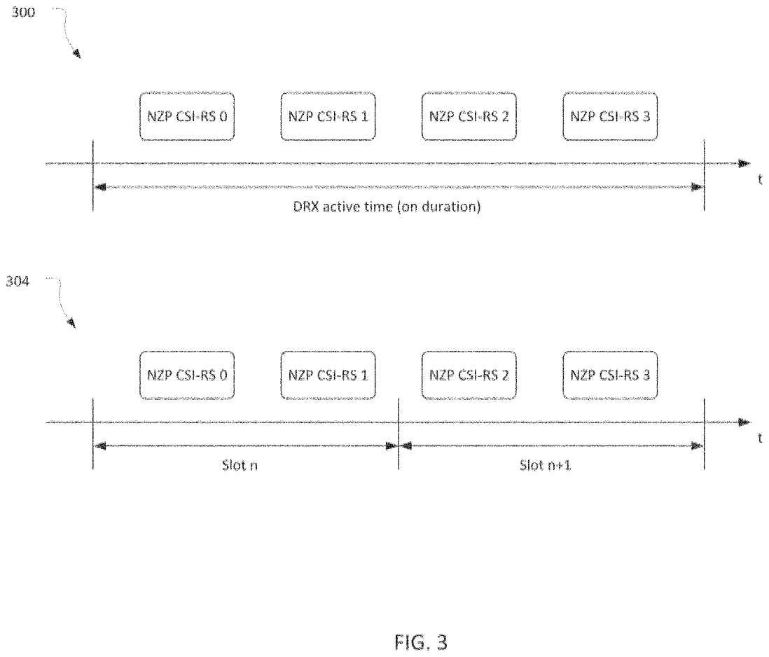

FIG. 3 illustrates signaling diagrams 300 and 304 that illustrate transmission of NZP-CSI-RSs in accordance with some embodiments.

The signaling diagram 300 illustrates transmission of four NZP-CSI RSs, NZP-CSI RS 0, NZP-CSI RS 1, NZP-CSI RS 2, and NZP-CSI RS 3, within a discontinuous reception (DRX) active time (which may also be defined as an “on duration”). Each of the four NZP-CSI RSs may be transmitted in respective NZP-CSI-RS resources. To ensure the NZP-CSI RSs are transmitted and arrive in the desired period, the CMR configuration may configure the N_{TRP} NZP-CSI-RS resources to occur in the same DRX active time.

The signaling diagram 304 illustrates transmission of four NZP-CSI RSs, NZP-CSI RS 0, NZP-CSI RS 1, NZP-CSI RS 2, and NZP-CSI RS 3, within X slots. Each of the four NZP-CSI RSs may be transmitted in respective NZP-CSI-RS resources. To ensure the NZP-CSI RSs are transmitted and arrive in the desired period, the CMR configuration may configure the N_{TRP} NZP-CSI-RS resources to occur in X consecutive slots. In some embodiments, X=1 or 2 (X=2 as shown in FIG. 3).

In another aspect of the disclosure, the number of unique transmission configuration indicator (TCI) states configured across the N_{TRP} NZP-CSI-RS resources may be limited. A TCI state may define a quasi-co-location (QCL) relationship between a QCL source and a target. Channel properties (for example, spatial, time, or frequency domain properties) experienced by the QCL source may be inferred with respect to the QCL target.

Different QCL types indicate different channel properties may be inferred. For example, QCL Type A corresponds to Doppler shift, Doppler Spread, average delay, and delay spread; QCL Type B corresponds to Doppler shift and Doppler spread; QCL Type C corresponds to Doppler shift and average delay; and QCL Type D corresponds to a spatial receiver (Rx) parameter. Thus, the UE 104 may determine channel properties by measuring a QCL source (e.g., a first reference signal) and use those channel properties when measuring a QCL target (e.g., an NZP-CSI RS).

While technically, each NZP-CSI-RS resource may be configured with a unique TCI state, the UE 104 may be restricted to receiving PDSCH transmissions with one or two unique TCI states. Given that the CSI report is to be used as the basis for scheduling a PDSCH, it may be advantageous to restrict the number of unique TCI states that may be configured across the N_{TRP} NZP-CSI-RS resources. In some embodiments, only one unique TCI state (with up to two QCL sources) may be configured across the N_{TRP} NZP-CSI-RS resources. In another embodiment, up to 2 unique TCI states (with each TCI state configured with up to two QCL sources) may be configured across the N_{TRP} NZP-CSI-RS resources.

In some instances, the access node 116 may configure a plurality of QCL sources for a TCI state. For example, one QCL source may be configured for digital beamforming and may be used for QCL type A, B, and C, while another QCL source may be configured for analog/spatial beamforming and may be used for QCL type D.

In some embodiments, for CMR configuration for mTRP CJT, across N_{TRP} NZP-CSI-RS Resources, in terms of the unique QCL source, the assumption of the number of unique QCL sources may be based on one or more of the following options.

In a first option, the number of unique QCL sources configured across all N_{TRP} NZP-CSI-RS resources can be different for different QCL types (or sets of QCL types). For example, for QCL type D, up to four unique QCL sources can be configured across all N_{TRP} NZP-CSI-RS resources. While for QCL type A, B, or C, up to two unique QCL sources can be configured across all N_{TRP} NZP-CSI-RS resources.

In a second option, the number of unique QCL sources configured across all N_{TRP} NZP-CSI-RS resources can be different for different QCL properties (or sets of QCL properties). For example, for spatial Rx parameter, up to four unique QCL sources can be configured across all N_{TRP} NZP-CSI-RS resources. While, for {Doppler shift, Doppler spread, average delay, delay spread}, up to two unique QCL sources can be configured across all N_{TRP} NZP-CSI-RS resources.

In some embodiments, for CMR configuration for mTRP CJT, across N_{TRP} NZP-CSI-RS Resources, whether multiple NZP-CSI-RS resources can overlap in time may be based on a frequency range in which intended mTRP CJT resides. For example, overlapping NZP-CSI-RS resources may be allowed in frequency range 1 (FR1), which may include frequencies below 7.125 GHz. FR1 communications may involve digital, rather than analog, beamforming and, therefore, the UE 104 may be capable of receiving NZP-CSI-RS transmitted on NZP-CSI-RS resources that overlap in the time domain. However, receiving overlapping NZP-CSI RSs may be more problematic in the higher frequencies, e.g., frequency range 2 (FR2) and above (e.g., above 24.250 GHz), that rely on analog beamforming. Thus, in some embodiments, overlapping NZP-CSI-RS resources may not be allowed, by default, for FR2 and above when the overlapping NZP-CSI-RS resources have different QCL Type D configurations.

In some embodiments, the UE 104 may provide in, e.g., a CMR processing capability report, whether the UE 104 can handle NZP-CSI-RS that overlap in the time domain on NZP-CSI-RS references with different QCL type D configurations.

Some embodiments describe aspects related to reporting CRI to the access node 116.

In a first aspect, for CMR configuration for mTRP CJT, when N_{TRP} NZP-CSI-RS resources are configured in the same NZP-CSI-RS-Resource set for CSI measurement, CRI may not be included in the CSI. Thus, in this case, the CSI may be calculated based on measurements of all N_{TRP} NZP-CSI-RS resources.

In a second aspect, for CMR configuration for mTRP CJT, when N_{TRP} NZP-CSI-RS resources are configured in the same NZP-CSI-RS-Resource set for CSI measurement, CRI may be included in the CSI using one or more of the following options.

In a first option, the CRI is used to report the strongest TRP. For example, the CRI may be the index of the NZP-CSI-RS resource corresponding to the strongest TRP.

In a second option, the CRI is used to perform dynamic point selection (DPS). In this option, the CRI may be used to indicate how many TRPs (or CSI-RS resources) are selected/reported among the N_{TRP} TRPs (or CSI-RS resources). For example, the UE 104 may provided an indication that the CQI/PMI of the CSI is computed based on a subset of the N_{TRP} CSI-RS resources, e.g., (e.g., two or three CSI-RS resources). However, with this option, the specific CSI-RS resources that are in the subset may not be reported. Additionally/alternatively, the CRI may be used to indicate which TRPs (or CSI-RS resources) are selected/reported among the N_{TRP} TRPs (or CSI-RS resources). Thus, with this option, the specific CSI-RS resources that are in the subset may be reported.

In a third aspect, for CMR configuration for mTRP CJT, the network (e.g., the access node 116) may configure whether the CRI is to be reported in the CSI. This indication may be included in the CMR configuration itself or in other signaling.

Some embodiments of the disclosure provide for configuration and use of IMR.

In a first aspect, for IMR configuration for mTRP CJT, when N_{TRP} NZP-CSI-RS resources are configured in the same NZP-CSI-RS-ResourceSet for CSI measurement, one or more of the following options may be used.

In a first option, IMR cannot be configured for CSI For mTRP CJT. Without configuration of IMR, the UE 104 may estimate the interference based on the CMR configuration. For example, the UE 104 may estimate the channel from the CMR and then remove the channel from the received signal and consider the rest the interference. In some embodiments, the UE 104 may estimate the energy and spatial structure of the interference based on the multi-antenna reception of the NZP-CSI RSs. This estimate may help with precoder selection. For example, if the UE 104 finds a null space in the interference, the UE 104 may select a PMI that forms a beam within that null space.

In a second option, only zero power (ZP) IMR can be configured for CSI or mTRP CJT. ZP IMR, which may also be referred to as CSI-IM, may define resource elements in which the access node 116 will deliberately not schedule transmissions. The UE 104 may measure the total received energy at its antennas during the ZP IMR to obtain an interference measurement. This interference measurement may be used as a basis for estimating a channel covariance matrix.

While ZP IMR provides the UE 104 a convenient way to measure interference, it may also result in less efficient usage of network resources.

In a third option, only NZP IMR can be configured for CSI for mTRP CJT. NZP IMR, which may be referred to as an NZP-CSI-RS resource, may be resource elements in which the access node 106 provides a transmission that mimics transmissions to/from a strong interferer. The UE 104 may measure these resource elements to determine an interference profile, which it may use to predict the type of receiver best suited to reject the interference.

In a fourth option, both ZP IMR and NZP IMR can be configured for CSI for mTRP CJT.

In a second aspect for IMR configuration for mTRP CJT, the UE 104 may provide a report on which it supports ZP IMR or NZP IMR. This report may be included in an IMR capability report transmitted with the CMR processing capabilities or separate therefrom.

In a third aspect for IMR configuration for mTRP CJT, when N_{TRP} NZP-CSI-RS resources are configured in the same NZP-CSI-RS-ResourceSet for CSI measurement, the IMR may be configured in accordance with one or more of the following options.

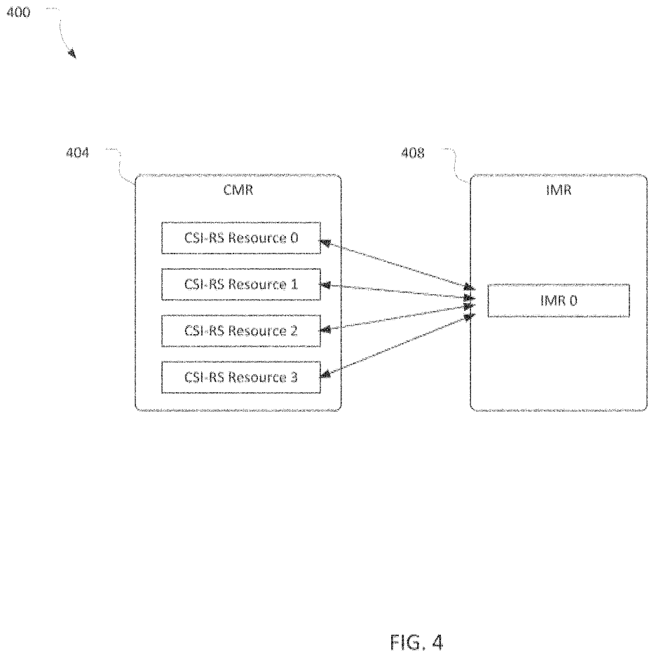

FIG. 4 illustrates an IMR-CMR mapping 400 in accordance with some embodiments. CMR 404 may be configured with N_{TRP} NZP-CSI-RS resources of an NZP-CSI-RS-resource set. As shown, the CMR 404 may be configured with four NZP-CSI-RS resources, similar to NZP-CSI-RS-resource set 200. The IMR 408 may be configured with a single IMR, IMR 0. In these embodiments, the same IMR may be mapped to each of the N_{TRP} NZP-CSI-RS resources. Thus, the UE 104 may use interference measurements from IMR 0 coupled with channel measurements from the NZP-CSI-RS resources 0-3 to calculate signal-to-interference-plus-noise ratios (SINRs) based on joint coherent transmission from N_{TRP} TRPs under the single interference represented by IMR 0 that may serve as the basis for determining the CSI.

In some embodiments, IMR 0 may be a ZP-IMR or a NZP-IMR.

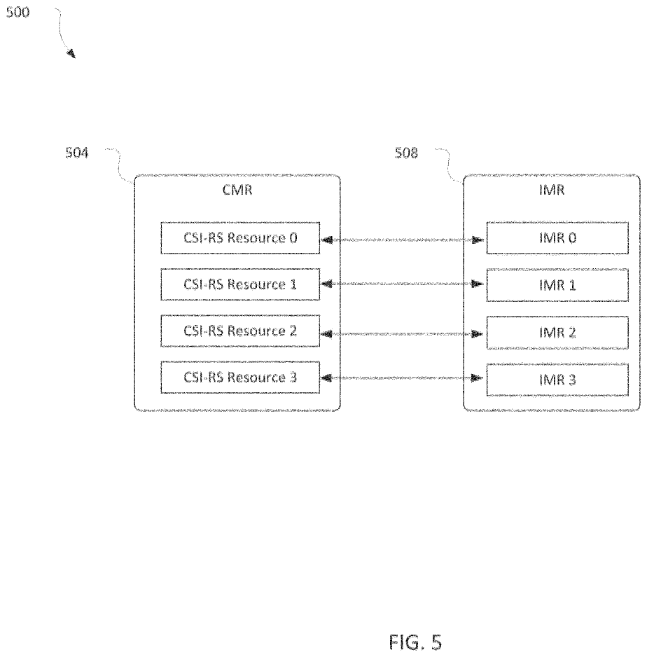

FIG. 5 illustrates an IMR-CMR mapping 500 in accordance with some embodiments. CMR 504 may be configured with N_{TRP} NZP-CSI-RS resources of an NZP-CSI-RS-resource set. As shown, the CMR 504 may be configured with four NZP-CSI-RS resources, similar to NZP-CSI-RS-resource set 200. In these embodiments, the IMR 508 may be configured with N_{TRP} IMRs, e.g., IMR 0, IMR 1, IMR 2, and IMR 3. In these embodiments, the N_{TRP} IMRs may be respectively mapped to the N_{TRP} NZP-CSI-RS resources as shown. Thus, the UE 104 may use interference measurements from IMR 0 coupled with channel measurements from NZP-CSI-RS resource 0 to calculate a first SINR, interference measurements from IMR 1 coupled with channel measurements from NZP-CSI-RS resource 1 to calculate a second SINR, etc. The four SINRs calculated in this manner may serve as a basis for determining the CSI.

Having an IMR mapped to each NZP-CSI-RS resource may be advantageous in more complicated multi-user MIMO scenarios. For example, having N_{TRP} IMRs respectively mapped to N_{TRP} CSI-RS resources may facilitate operation if a TRP is to co-schedule other UEs for transmissions independent from the mTRP CJT.

In some embodiments, the TCI State (QCL) of each IMR is assumed to be the same as the corresponding CSI-RS resource.

In some embodiments, the N_{TRP} IMRs may be any combination of ZP-IMR or a NZP-IMRs.

In some embodiments, the type of IMR (e.g., ZP-IMR or a NZP-IMR) that is configured may be based on whether one IMR is mapped to the N_{TRP} CSI-RS resources or whether N_{TRP} IMRs are respectively mapped to N_{TRP} CSI-RS resources. For example, the ZP-IMR may be sufficient and desirable to support embodiments in which one IMR is mapped to the N_{TRP} CSI-RS resources, while the NZP-IMR may be more useful for embodiments in which N_{TRP} IMRs are respectively mapped to N_{TRP} CSI-RS resources.

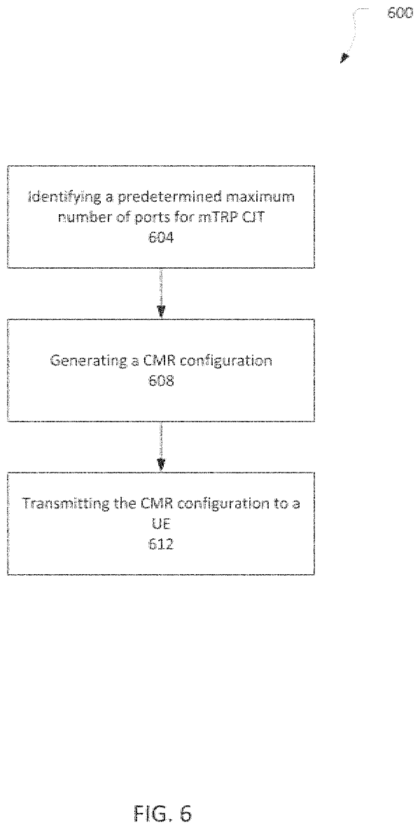

FIG. 6 illustrates an operational flow/algorithmic structure 600 for configuring CMR in accordance with some embodiments. The operational flow/algorithmic structure 600 may be implemented by an access node such as, for example, access node 116, network device 1000, or components therein, for example, processing circuitry 1004.

The operational flow/algorithmic structure 600 may include, at 604, identifying a predetermined maximum number of ports for an mTRP CJT. The predetermined maximum number, which may be defined in a specification (e.g., a 3GPP TS), may be 32 or 64 in some embodiments.

The operational flow/algorithmic structure 600 may further include, at 608, generating a CMR configuration. The CMR configuration may be used to configure transmission of N_{TRP} NZP-CSI-RSs using N_{TRP} NZP-CSI-RS resources of an NZP-CSI-RS-resource set. Each NZP-CSI-RS may be transmitted by a respective TRP. In transmitting the NZP-CSI RS, the TRP may use a number of antenna ports equal to the predetermined maximum number of ports divided by N_{TRP}.

The operational flow/algorithmic structure 600 may further include, at 612, transmitting the CMR configuration to a UE. The CMR configuration may be transmitted using RRC signaling.

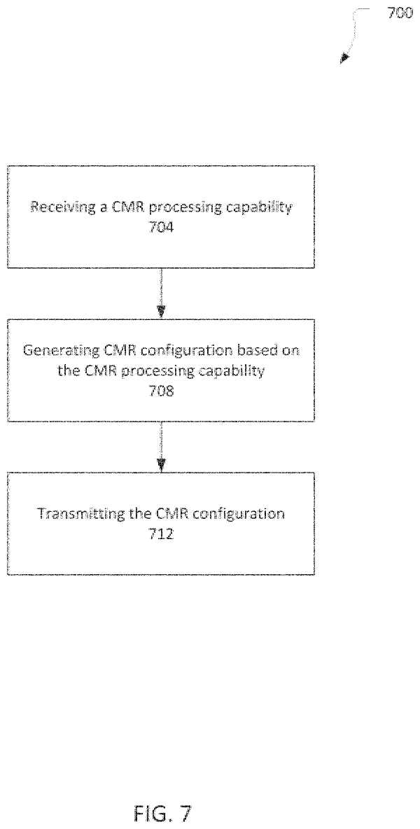

FIG. 7 illustrates an operational flow/algorithmic structure 700 for configuring CMR in accordance with some embodiments. The operational flow/algorithmic structure 700 may be implemented by an access node such as, for example, access node 116, network device 1000, or components therein, for example, processing circuitry 1004.

The operational flow/algorithmic structure 700 may include, at 704, receiving a CMR processing capability. The CMR processing capability may be received from the UE and may include information relevant to UE's capability of processing NZP-CSI-RS resources of an NZP-CSI-RS-resource set.

In some embodiments, the CMR processing capability may include one or more triplets. Each triplet may include a maximum total number of NZP-CSI-RS resources the UE is capable of simultaneously processing across all component carriers; a maximum total number of NZP-CSI-RS ports the UE is capable of simultaneously processing across all component carriers; and a maximum number of NZP CSI-RS ports the UE is capable of processing across M NZP-CSI-RS resources. The value M may be one NZP-CSI-RS resource or all of the NZP-CSI-RS resources of an NZP-CSI-RS-resource set (e.g., N_{TRP} NZP-CSI-RS resources).

The operational flow/algorithmic structure 700 may further include, at 708, generating a CMR configuration based on the CMR processing capability. The CMR configuration may be used to configure transmission of N_{TRP} NZP-CSI-RSs using N_{TRP} NZP-CSI-RS resources of an NZP-CSI-RS-resource set. The CMR configuration may include configurations dedicated to specific NZP-CSI-RS resources (e.g., NZP-CSI-RS-resource configurations) or to the NZP-CSI-RS-resource set (e.g., NZP-CSI-RS-resource-set configuration).

In some embodiments, the CMR configuration may include one or more IEs to include parameters the UE may use for various CSI-related calculations. For example, the IEs may provide a power control offset to be used for CQI calculation; a power control offset synchronization signal to be used for an open loop power control process; or a periodicity and offset to configure a time-domain pattern of a periodic NZP-CSI RS. One or more of these parameters may be set at the same value across the N_{TRP} NZP-CSI-RS resources of the NZP-CSI-RS-resource set.

The operational flow/algorithmic structure 700 may further include, at 712, transmitting the CMR configuration to a UE. The CMR configuration may be transmitted using RRC signaling.

In some embodiments, the CMR configuration may configure N_{TRP} NZP-CSI-RS resources in manner such that all N_{TRP} NZP-CSI RSs are transmitted within a predetermined period of time. The predetermined period of time may be a DRX active time (e.g., on duration) or within a predetermined number of slots.

In some embodiments, the CMR configuration may configure N_{TRP} NZP-CSI-RS resources with one or two unique TCI states.

In some embodiments, the CMR configuration may configure the N_{TRP} NZP-CSI-RS resources with unique QCL sources based on QCL type or parameter. For example, in some embodiments, the CMR configuration may configure a first set of the NZP-CSI-RS resources of the N_{TRP} NZP-CSI-RSs resources that are associated with QCL type D with up to four unique QCL sources and a second set of NZP-CSI-RS resources of the N_{TRP} NZP-CSI-RSs resources that are associated with QCL type A, B, or C with up to two unique QCL sources. In other embodiments, the CMR configuration may configure a first set of the NZP-CSI-RS resources of the N_{TRP} NZP-CSI-RSs resources that are associated with a spatial Rx QCL property with up to four unique QCL sources and a second set of NZP-CSI-RS resources of the N_{TRP} NZP-CSI-RSs resources that are associated with a Doppler shift, Doppler spread, average delay, or delay spread QCL property with up to two unique QCL sources.

In some embodiments, the CMR configuration may cause at least two NZP-CSI RSs to be overlapped in a time domain. This may be based on frequency range in which the mTRP CJT is to be transmitted, TCI state configured, or capabilities of the UE.

In some embodiments, the CMR configuration may provide an indication of whether the UE is to include a CRI in a CSI report. If the UE is to include a CRI in the CSI report, the CMR configuration may also indicate what type of CRI is to be included, for example, whether the CRI is to indicate a number of NZP-CSI-RSs that serve as the basis for the CSI or the index of the specific NZP-CSI-RSs that serve as the basis for the CSI

The operational flow/algorithmic structure 700 may further include, at 712, transmitting the CMR configuration to a UE. The CMR configuration may be transmitted using RRC signaling.

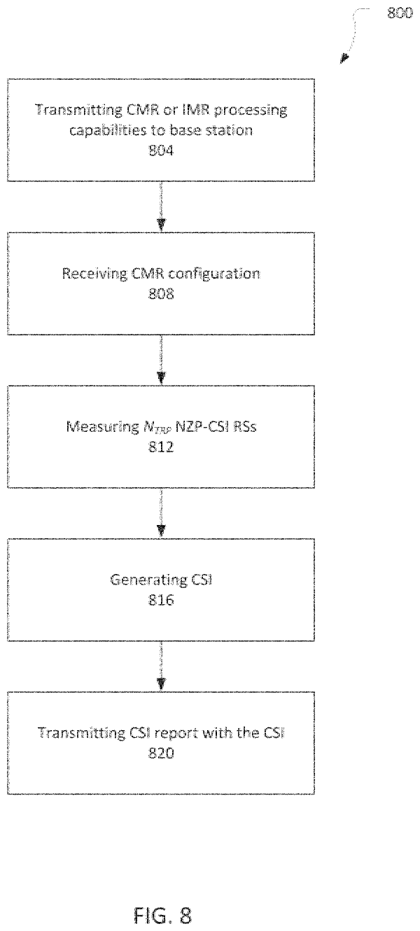

FIG. 8 illustrates an operational flow/algorithmic structure 800 for CSI reporting in accordance with some embodiments. The operational flow/algorithmic structure 800 may be implemented by a UE such as, for example, UE 104 or 900 or components therein, for example, processing circuitry 904.

The operational flow/algorithmic structure 800 may include, at 804, transmitting CMR or IMR processing capabilities to a base station.

In some embodiments, the CMR processing capability may be transmitted with one or more triplets. Each triplet may include a maximum total number of NZP-CSI-RS resources the UE is capable of simultaneously processing across all component carriers; a maximum total number of NZP-CSI-RS ports the UE is capable of simultaneously processing across all component carriers; and a maximum number of NZP CSI-RS ports the UE is capable of processing across M NZP-CSI-RS resources. The value M may be one NZP-CSI-RS resource or all of the NZP-CSI-RS resources of an NZP-CSI-RS-resource set (e.g., N_{TRP} NZP-CSI-RS resources).

In some embodiments, the CMR processing capability may be transmitted with an indication of whether the UE can handle overlapping NZP-CSI RSs with different QCL type D configurations.

In some embodiments, the IMR processing capability may be transmitted with an indication of whether the UE supports ZP-IMR or NZP-IMR.

The operational flow/algorithmic structure 800 may further include, at 808, receiving a CMR configuration. The CMR configuration may be used to configure transmission of N_{TRP} NZP-CSI-RSs using N_{TRP} NZP-CSI-RS resources of an NZP-CSI-RS-resource set for an mTRP CJT.

The operational flow/algorithmic structure 800 may further include, at 812, measuring N_{TRP} NZP-CSI RSs. The N_{TRP} NZP-CSI RSs may be measured based on the configuration of the N_{TRP} NZP-CSI-RS resources from the CMR configuration.

The operational flow/algorithmic structure 800 may further include, at 816, generating CSI. The CSI may be generated with CQI, RI, and a PMI. These indicators may be selected/calculated based on measurements of one or more of the N_{TRP} NZP-CSI-RS resources as configured by the CMR configuration. In some embodiments, these indicator may be selected/calculated based further on interference measurements of one or more IMRs configured by an IMR configuration. The one or more IMRs may include ZP IMRs or NZP IMRs. In some embodiments, one IMR may be configured to correspond to the N_{TRP} NZP-CSI-RS resources. In other embodiments, N_{TRP} IMRs may be configured to respectively correspond to the N_{TRP} NZP-CSI-RS resources.

The operational flow/algorithmic structure 800 may further include, at 820, transmitting the CSI in a CSI report.

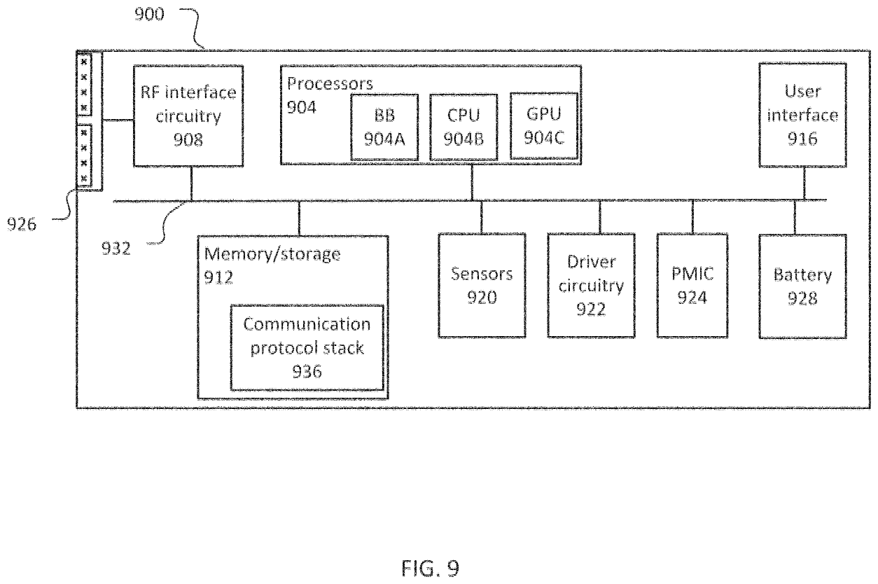

FIG. 9 illustrates a UE 900 in accordance with some embodiments. The UE 900 may be similar to and substantially interchangeable with UE 104 of FIG. 1.

The UE 900 may be any mobile or non-mobile computing device, such as, for example, a mobile phone, computer, tablet, XR device, glasses, industrial wireless sensor (for example, microphone, carbon dioxide sensor, pressure sensor, humidity sensor, thermometer, motion sensor, accelerometer, laser scanner, fluid level sensor, inventory sensor, electric voltage/current meter, or actuator), video surveillance/monitoring device (for example, camera or video camera), wearable device (for example, a smart watch), or Internet-of-things device.

The UE 900 may include processors 904, RF interface circuitry 908, memory/storage 912, user interface 916, sensors 920, driver circuitry 922, power management integrated circuit (PMIC) 924, antenna structure 926, and battery 928. The components of the UE 900 may be implemented as integrated circuits (ICs), portions thereof, discrete electronic devices, or other modules, logic, hardware, software, firmware, or a combination thereof. The block diagram of FIG. 9 is intended to show a high-level view of some of the components of the UE 900. However, some of the components shown may be omitted, additional components may be present, and different arrangement of the components shown may occur in other implementations.

The components of the UE 900 may be coupled with various other components over one or more interconnects 932, which may represent any type of interface, input/output, bus (local, system, or expansion), transmission line, trace, or optical connection that allows various circuit components (on common or different chips or chipsets) to interact with one another.

The processors 904 may include processor circuitry such as, for example, baseband processor circuitry (BB) 904A, central processor unit circuitry (CPU) 904B, and graphics processor unit circuitry (GPU) 904C. The processors 904 may include any type of circuitry or processor circuitry that executes or otherwise operates computer-executable instructions, such as program code, software modules, or functional processes from memory/storage 912 to cause the UE 900 to perform operations as described herein.

In some embodiments, the baseband processor circuitry 904A may access a communication protocol stack 936 in the memory/storage 912 to communicate over a 3GPP compatible network. In general, the baseband processor circuitry 904A may access the communication protocol stack 936 to: perform user plane functions at a PHY layer, MAC layer, RLC sublayer, PDCP sublayer, SDAP sublayer, and upper layer; and perform control plane functions at a PHY layer, MAC layer, RLC sublayer, PDCP sublayer, RRC layer, and a NAS layer. In some embodiments, the PHY layer operations may additionally/alternatively be performed by the components of the RF interface circuitry 908.

The baseband processor circuitry 904A may generate or process baseband signals or waveforms that carry information in 3GPP-compatible networks. In some embodiments, the waveforms for NR may be based cyclic prefix OFDM (CP-OFDM) in the uplink or downlink, and discrete Fourier transform spread OFDM (DFT-S-OFDM) in the uplink.

The memory/storage 912 may include one or more non-transitory, computer-readable media that includes instructions (for example, communication protocol stack 936) that may be executed by one or more of the processors 904 to cause the UE 900 to perform various CSI reporting operations as described herein. For example, the processors 904 may cause the UE to perform the operational flow/algorithmic structure 800 or any other method or process describe herein.

The memory/storage 912 include any type of volatile or non-volatile memory that may be distributed throughout the UE 900. In some embodiments, some of the memory/storage 912 may be located on the processors 904 themselves (for example, L1 and L2 cache), while other memory/storage 912 is external to the processors 904 but accessible thereto via a memory interface. The memory/storage 912 may include any suitable volatile or non-volatile memory such as, but not limited to, dynamic random access memory (DRAM), static random access memory (SRAM), erasable programmable read only memory (EPROM), electrically erasable programmable read only memory (EEPROM), Flash memory, solid-state memory, or any other type of memory device technology.

The RF interface circuitry 908 may include transceiver circuitry and radio frequency front module (RFEM) that allows the UE 900 to communicate with other devices over a radio access network. The RF interface circuitry 908 may include various elements arranged in transmit or receive paths. These elements may include, for example, switches, mixers, amplifiers, filters, synthesizer circuitry, and control circuitry.

In the receive path, the RFEM may receive a radiated signal from an air interface via antenna structure 926 and proceed to filter and amplify (with a low-noise amplifier) the signal. The signal may be provided to a receiver of the transceiver that down-converts the RF signal into a baseband signal that is provided to the baseband processor of the processors 904.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna structure 926.

In various embodiments, the RF interface circuitry 908 may be configured to transmit/receive signals in a manner compatible with NR access technologies.

The antenna structure 926 may include antenna elements to convert electrical signals into radio waves to travel through the air and to convert received radio waves into electrical signals. The antenna elements may be arranged into one or more antenna panels.

The antenna structure 926 may have antenna panels that are omnidirectional, directional, or a combination thereof to enable beamforming and multiple input, multiple output communications. The antenna structure 926 may include microstrip antennas, printed antennas fabricated on the surface of one or more printed circuit boards, patch antennas, or phased array antennas. The antenna structure 926 may have one or more panels designed for specific frequency bands including bands in FR1 or FR2.

The user interface 916 includes various input/output (I/O) devices designed to enable user interaction with the UE 900. The user interface 916 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes (LEDs) and multi-character visual outputs, or more complex outputs such as display devices or touchscreens (for example, liquid crystal displays (LCDs), LED displays, quantum dot displays, and projectors), with the output of characters, graphics, multimedia objects, and the like being generated or produced from the operation of the UE 900.

The sensors 920 may include devices, modules, or subsystems whose purpose is to detect events or changes in its environment and send the information (sensor data) about the detected events to some other device, module, or subsystem. Examples of such sensors include inertia measurement units comprising accelerometers, gyroscopes, or magnetometers; microelectromechanical systems or nanoelectromechanical systems comprising 3-axis accelerometers, 3-axis gyroscopes, or magnetometers; level sensors; flow sensors; temperature sensors (for example, thermistors); pressure sensors; barometric pressure sensors; gravimeters; altimeters; image capture devices (for example, cameras or lensless apertures); light detection and ranging sensors; proximity sensors (for example, infrared radiation detector and the like); depth sensors; ambient light sensors; ultrasonic transceivers; and microphones or other like audio capture devices.

The driver circuitry 922 may include software and hardware elements that operate to control particular devices that are embedded in the UE 900, attached to the UE 900, or otherwise communicatively coupled with the UE 900. The driver circuitry 922 may include individual drivers allowing other components to interact with or control various I/O devices that may be present within, or connected to, the UE 900. For example, the driver circuitry 922 may include circuitry to facilitate coupling of a UICC (for example, UICC 98) to the UE 900. For additional examples, driver circuitry 922 may include a display driver to control and allow access to a display device, a touchscreen driver to control and allow access to a touchscreen interface, sensor drivers to obtain sensor readings of sensors 920 and control and allow access to sensors 920, drivers to obtain actuator positions of electro-mechanic components or control and allow access to the electro-mechanic components, a camera driver to control and allow access to an embedded image capture device, audio drivers to control and allow access to one or more audio devices.

The PMIC 924 may manage power provided to various components of the UE 900. In particular, with respect to the processors 904, the PMIC 924 may control power-source selection, voltage scaling, battery charging, or DC-to-DC conversion.

In some embodiments, the PMIC 924 may control, or otherwise be part of, various power saving mechanisms of the UE 900 including DRX as discussed herein.

A battery 928 may power the UE 900, although in some examples the UE 900 may be mounted deployed in a fixed location, and may have a power supply coupled to an electrical grid. The battery 928 may be a lithium ion battery, a metal-air battery, such as a zinc-air battery, an aluminum-air battery, a lithium-air battery, and the like. In some implementations, such as in vehicle-based applications, the battery 928 may be a typical lead-acid automotive battery.

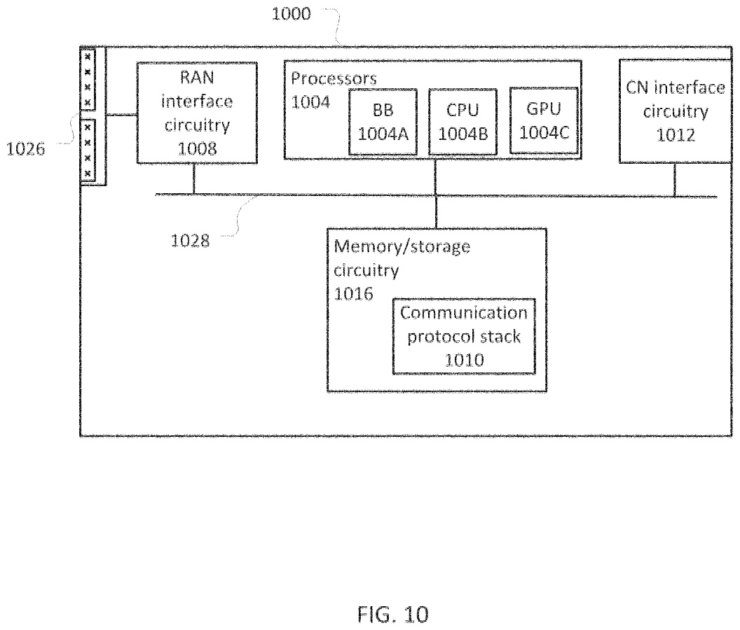

FIG. 10 illustrates a network node 1000 in accordance with some embodiments. The network node 1000 may be similar to and substantially interchangeable with access node 106 or base station 108.

The network node 1000 may include processors 1004, RF interface circuitry 1008 (if implemented as an access node), core network (CN) interface circuitry 1012, memory/storage circuitry 1016, and antenna structure 1026.

The components of the network node 1000 may be coupled with various other components over one or more interconnects 1028.

The processors 1004, RF interface circuitry 1008, memory/storage 1016 (including communication protocol stack 1010), antenna structure 1026, and interconnects 1028 may be similar to like-named elements shown and described with respect to FIG. 9.

The memory/storage 1016 may include one or more non-transitory, computer-readable media that includes instructions (for example, communication protocol stack 1010) that may be executed by one or more of the processors 1004 to cause the network node 1000 to perform paging operations as described herein. For example, the processors 1004 may cause the network node 1000 to perform the operational flow/algorithmic structure 800 or any other method or process described herein.

The CN interface circuitry 1012 may provide connectivity to a core network, for example, a 5th Generation Core network (5GC) using a 5GC-compatible network interface protocol such as carrier Ethernet protocols, or some other suitable protocol. Network connectivity may be provided to/from the network node 1000 via a fiber optic or wireless backhaul. The CN interface circuitry 1012 may include one or more dedicated processors or FPGAs to communicate using one or more of the aforementioned protocols. In some implementations, the CN interface circuitry 1012 may include multiple controllers to provide connectivity to other networks using the same or different protocols.

In some embodiments, the network node 1000 may be coupled with transmit receive points (TRPs) using the antenna structure 1026, CN interface circuitry, or other interface circuitry.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

For one or more aspects, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

### EXAMPLES

In the following sections, further exemplary aspects are provided.

Example 1 includes a method of operating an access node, the method comprising: identifying a predetermined maximum number of ports for a multi-transmit-receive point (mTRP) coherent joint transmission; generating a channel measurement resource (CMR) configuration to configure transmission of a number of non-zero power (NZP)-channel state information (CSI) reference signals (RSs); and transmitting the CMR configuration to a user equipment (UE).

Example 2 includes the method of example 1 or some other example herein, wherein the number is a first number and the method further comprises: transmitting, by a first transmit-receive point (TRP), an NZP CSI-RS of the first number of NZP-CSI RSs using a second number of antenna ports, wherein the second number is equal to the predetermined maximum number divided by the first number.

Example 3 includes the method of example 2 or some other example herein, further comprising: transmitting the first number of NZP-CSI RSs using a respective first number of TRPs.

Example 4 includes the method of example 1 or some other example herein, wherein the predetermined maximum number is 32 or 64.

Example 5 includes a method of operating an access node, the method comprising: receiving, from a user equipment (UE), a channel measurement resource (CMR) processing capability; generating, based on the CMR processing capability, a CMR configuration to configure transmission of a number of non-zero power (NZP)-channel state information (CSI) reference signals (RSs) to support a multi-transmit-receive point (mTRP) coherent joint transmission; and transmitting the CMR configuration to the UE.

Example 6 includes the method of example 5 or some other example herein, wherein the CMR processing capability includes: a maximum total number of NZP-CSI-RS resources the UE is capable of simultaneously processing across all component carriers; a maximum total number of NZP-CSI-RS ports the UE is capable of simultaneously processing across all component carriers; and a maximum number of NZP CSI-RS ports the UE is capable of processing across one or more NZP-CSI-RS resources.

Example 7 includes a method of example 6 or some other example herein, wherein the number of NZP-CSI RSs comprises N_{TRP} NZP-CSI RSs, wherein N_{TRP} is an integer, and the one or more NZP-CSI-RS resources comprises one NZP-CSI-RS resource or N_{TRP} NZP-CSI-RS resources.

Example 8 includes the method of example 5 or some other example herein, wherein the CMR configuration comprises: a power control offset to be used for channel quality indicator (CQI) calculation; a power control offset synchronization signal to be used for an open loop power control process; or a periodicity and offset to configure a time-domain pattern of a periodic NZP-CSI RS.

Example 9 includes the method of example 5 or some other example herein, wherein the CMR configuration is to: configure a first NZP-CSI-RS-Resource of a NZP-CSI-RS-Resource set with a first value of a configuration parameter, the configuration parameter to include a power control offset to be used for channel quality indicator (CQI) calculation or a periodicity and offset to configure a time-domain pattern of a periodic NZP-CSI RS; and configure a second NZP-CSI-RS-Resource of the NZP-CSI-RS-Resource set with the first value of the configuration parameter.

Example 10 includes the method of example 5 or some other example herein, wherein the number of NZP-CSI RSs comprises N_{TRP} NZP-CSI RSs, where N_{TRP} is an integer, and the CMR configuration comprises: N_{TRP} NZP-CSI-RS-Resource configurations to configure N_{TRP} NZP-CSI-RS resources of an NZP-CSI-RS-resource set for transmission of the N_{TRP} NZP-CSI RSs, wherein each of the N_{TRP} NZP-CSI-RS-Resource configurations includes a respective power control offset.

Example 11 includes a method of example 5 or some other example herein, wherein the number of NZP-CSI RSs comprises N_{TRP} NZP-CSI RSs, where N_{TRP} is an integer, and the method further comprises: causing transmission of the N_{TRP} NZP-CSI RSS within a predetermined period of time, wherein the predetermined period of time is a discontinuous reception (DRX) active time or within a predetermined number of slots.

Example 12 includes the method of example 5 or some other example herein, wherein the number of NZP-CSI RSs comprises N_{TRP} NZP-CSI RSs, where N_{TRP} is an integer, and the CMR configuration is to: configure N_{TRP} NZP-CSI-RSs resources for the N_{TRP} NZP-CSI RSs, wherein a first set of the NZP-CSI-RS resources of the N_{TRP} NZP-CSI-RSs resources that are associated with quasi-co-location (QCL) type D are configured with up to four unique QCL sources and a second set of NZP-CSI-RS resources of the N_{TRP} NZP-CSI-RSs resources that are associated with QCL type A, B, or C are configured with up to two unique QCL sources.

Example 13 includes a method of example 5 or some other example herein, wherein the number of NZP-CSI RSs comprises N_{TRP} NZP-CSI RSs, where N_{TRP} is an integer, and the CMR configuration is to configure N_{TRP} NZP-CSI-RSs resources for the N_{TRP} NZP-CSI RSs, wherein a first set of the NZP-CSI-RS resources of the N_{TRP} NZP-CSI-RSs resources that are associated with a spatial receiver parameter quasi-co-location (QCL) property are configured with up to four unique QCL sources and a second set of NZP-CSI-RS resources of the N_{TRP} NZP-CSI-RSs resources that are associated with a Doppler shift, Doppler spread, average delay, or delay spread QCL property are configured with up to two unique QCL sources.

Example 14 includes the method of example 5 or some other example herein, wherein the mTRP coherent joint transmission is to be transmitted in frequency range 1 and the method further comprises: generating the CMR configuration to cause at least two NZP-CSI RSs of the number of NZP-CSI RSs to overlap in a time domain.

Example 15 includes the method of example 5 or some other example herein, wherein the mTRP coherent joint transmission is to be transmitted in frequency range 2 and the method further comprises: generating the CMR configuration to cause a plurality of NZP-CSI RSs of the number of NZP-CSI RSs that are associated with different spatial receiver (Rx) parameters to not overlap in a time domain.

Example 16 includes the method of example 5 or some other example herein, wherein the mTRP coherent joint transmission is to be transmitted in frequency range 2 and the method further comprises: determining, based on the CMR processing capability, that the UE supports overlapping NZP-CSI RSs that are associated with different spatial receiver (Rx) parameters; and generating, based on the CMR processing capability, the CMR configuration to cause a plurality of NZP-CSI RSs of the number of NZP-CSI-RSs that are associated with different spatial Rx parameters to overlap in a time domain.

Example 17 includes the method of example 5 or some other example herein, the number of NZP-CSI RSs comprises N_{TRP} NZP-CSI RSs, where N_{TRP} is an integer, and the method further comprises: causing transmission of the N_{TRP} NZP-CSI RSs by N_{TRP} transmit-receive points (TRPs), respectively; and receiving, from the UE, CSI corresponding to at least one of the N_{TRP} NZP-CSI RSs.

Example 18 includes the method of example 17 or some other example herein, wherein the at least one of the N_{TRP} NZP-CSI RSs comprises all of the N_{TRP} NZP-CSI RSs and the CSI does not include a CSI-RS resource indicator.

Example 19 includes the method of example 17 or some other example herein, wherein the at least one of the N_{TRP} NZP-CSI RSs comprises a subset of the N_{TRP} NZP-CSI RSs and the CSI includes a CSI-RS resource indicator (CRI).

Example 20 includes the method of example 19 or some other example herein, wherein the CRI comprises an index of an NZP-CSI RS of the N_{TRP} NZP-CSI RSs that is associated with a strongest measurement of the N_{TRP} NZP-CSI RSs.

Example 21 includes the method of example 19 or some other example herein, wherein the CRI comprises an indication of a number of NZP-CSI RSs of the subset of the NZP-CSI RSs or comprises an index corresponding to each NZP-CSI RSs of the subset of NZP-CSI RSs.

Example 22 includes the method of example 5 or some other example herein, wherein the CMR configuration is to indicate whether the UE is to include a CSI-RS resource indicator in a CSI report.

Example 23 includes a method of operating a user equipment (UE), the method comprising: transmitting, to a base station, channel measurement resource (CMR) or interference measurement resource (IMR) processing capabilities of the UE; receiving a channel measurement resource (CMR) configuration to configure N_{TRP} non-zero power (NZP) channel state information (CSI)-reference signal (RS) resources to support a multi-transmit-receive point (mTRP) coherent joint transmission, wherein N_{TRP} is an integer; measuring N_{TRP} NZP-CSI reference signals (RSs) transmitted on the N_{TRP} NZP-CSI-RS resources; generating (CSI) corresponding to at least some of the N_{TRP} NZP-CSI reference signals (RSs) based on measuring the N_{TRP} NZP-CSI RSs; and transmitting a CSI report with the CSI to a base station.

Example 24 includes the method of example 23 or some other example herein, further comprising: receiving an IMR configuration to configure one or more IMRs, the one or more IMRs to include zero power (ZP) IMRs or nonzero power (NZP) IMRs; and measuring the one or more IMRs; and generating the CSI based further on measuring the one or more IMRs.

Example 25 includes a method of example 24 some other example herein, wherein the one or more IMRs include only one or more ZP IMRs or include only one or more NZP IMRs.

Example 26 includes a method of example 24 some other example herein, further comprising: transmitting IMR processing capabilities of the UE to the base station, wherein the IMR processing capabilities indicate the UE supports ZP IMR or NZP IMR.

Example 27 includes the method of example 24 some other example herein, wherein: the one or more IMRs include one IMR mapped to the N_{TRP} NZP-CSI-RS resources; or the one or more IMRs include the N_{TRP} IMRs respectively mapped to the N_{TRP} NZP-CSI-RS resources.

Example 28 includes the method of example 23 some other example herein, wherein the CMR configuration includes N_{TRP} power control offsets that respectively correspond to the N_{TRP} NZP-CSI-RS resources and the method further comprises: calculating an average power control offset based on the N_{TRP} power control offsets; determining a channel quality indicator (CQI) based on the average power control offset; and generating the CSI to include the CQI.

Example 29 includes the method of example 23 or some other example herein, wherein the CMR configuration includes N_{TRP} power control offsets that respectively correspond to the N_{TRP} NZP-CSI-RS resources and the method further comprises: determining a channel quality indicator (CQI) for each of the N_{TRP} NZP-CSI-RS resources based on a corresponding power control offset; and generating the CSI to include the CQIs for each of the N_{TRP} NZP-CSI-RS resources.

Another example may include one or more non-transitory computer-readable media comprising instructions to cause an electronic device, upon execution of the instructions by one or more processors of the electronic device, to perform one or more elements of a method described in or related to any of examples 1-29, or any other method or process described herein.

Another example may include an apparatus comprising logic, modules, or circuitry to perform one or more elements of a method described in or related to any of examples 1-29, or any other method or process described herein.

Another example may include a method, technique, or process as described in or related to any of examples 1-29, or portions or parts thereof.

Another example may include an apparatus comprising: one or more processors and one or more computer-readable media comprising instructions that, when executed by the one or more processors, cause the one or more processors to perform the method, techniques, or process as described in or related to any of examples 1-29, or portions thereof.

Another example include a signal as described in or related to any of examples 1-29, or portions or parts thereof.

Another example may include a datagram, information element, packet, frame, segment, PDU, or message as described in or related to any of examples 1-29, or portions or parts thereof, or otherwise described in the present disclosure.

Another example may include a signal encoded with data as described in or related to any of examples 1-29, or portions or parts thereof, or otherwise described in the present disclosure.

Another example may include a signal encoded with a datagram, IE, packet, frame, segment, PDU, or message as described in or related to any of examples 1-29, or portions or parts thereof, or otherwise described in the present disclosure.

Another example may include an electromagnetic signal carrying computer-readable instructions, wherein execution of the computer-readable instructions by one or more processors is to cause the one or more processors to perform the method, techniques, or process as described in or related to any of examples 1-29, or portions thereof.

Another example may include a computer program comprising instructions, wherein execution of the program by a processing element is to cause the processing element to carry out the method, techniques, or process as described in or related to any of examples 1-29, or portions thereof.

Another example may include a signal in a wireless network as shown and described herein.

Another example may include a method of communicating in a wireless network as shown and described herein.

Another example may include a system for providing wireless communication as shown and described herein.

Another example may include a device for providing wireless communication as shown and described herein.

Any of the above-described examples may be combined with any other example (or combination of examples), unless explicitly stated otherwise. The foregoing description of one or more implementations provides illustration and description, but is not intended to be exhaustive or to limit the scope of aspects to the precise form disclosed. Modifications and variations are possible in light of the above teachings or may be acquired from practice of various aspects.

Although the aspects above have been described in considerable detail, numerous variations and modifications will become apparent to those skilled in the art once the above disclosure is fully appreciated. It is intended that the following claims be interpreted to embrace all such variations and modifications.

1.-25. (canceled)

26. A method comprising:
receiving, from a user equipment (UE), a channel measurement resource (CMR) processing capability;
generating a CMR configuration to configure a number of non-zero power (NZP) channel state information (CSI)-reference signal (RS) resources to support a multi-transmit-receive point (mTRP) coherent joint transmission (CJT); and
outputting the CMR configuration for transmission to the UE.

27. The method of claim 26, wherein the CMR processing capability is to indicate UE support for: a maximum number of transmit ports per NZP CSI-RS resource for the mTRP CJT; a maximum total number of NZP CSI-RS resources associated with the mTRP CJT; and a maximum total number of transmit ports of NZP CSI-RS resources associated with the mTRP CJT.

28. The method of claim 26, wherein the CMR configuration is to configure all NZP CSI-RS resources of an NZP CSI-RS resource set to be transmitted within a discontinuous reception (DRX) active time.

29. The method of claim 26, wherein the CMR configuration comprises:
a power control offset to be used for channel quality indicator (CQI) calculation;
a power control offset synchronization signal to be used for an open loop power control process; or a periodicity and offset to configure a time-domain pattern of a periodic NZP CSI-RS resource.

30. The method of claim 26, wherein the CMR configuration is to:
configure a first NZP CSI-RS resource of a NZP CSI-RS resource set with a first value of a configuration parameter, the configuration parameter to include a power control offset to be used for channel quality indicator (CQI) calculation or a periodicity and offset to configure a time-domain pattern of a periodic NZP CSI-RS; and
configure a second NZP CSI-RS resource of the NZP CSI-RS resource set with the first value of the configuration parameter.

31. The method of claim 26, wherein the number of NZP CSI-RS resources comprises N_{TRP} NZP CSI-RS resources, where N_{TRP} is an integer, and the CMR configuration comprises:
N_{TRP} NZP CSI-RS resource configurations to configure the N_{TRP} NZP CSI-RS resources of an NZP CSI-RS resource set, wherein each of the N_{TRP} NZP CSI-RS resource configurations includes a respective power control offset.

32. The method of claim 26, wherein: the number of NZP CSI-RS resources comprises N_{TRP} NZP CSI-RS resources, where N_{TRP} is an integer; a first set of the N_{TRP} NZP CSI-RS resources are associated with quasi-co-location (QCL) type D and are configured with up to four unique QCL sources; and a second set of the N_{TRP} NZP CSI-RS resources are associated with QCL type A, B, or C and are configured with up to two unique QCL sources.

33. The method of claim 26, wherein: the number of NZP CSI-RS resources comprises N_{TRP} NZP CSI-RS resources, where N_{TRP} is an integer; a first set of the N_{TRP} NZP CSI-RS resources are associated with a spatial receiver parameter quasi-co-location (QCL) property and are configured with up to four unique QCL sources; and a second set of the N_{TRP} NZP CSI-RS resources are associated with a Doppler shift, Doppler spread, average delay, or delay spread QCL property and are configured with up to two unique QCL sources.

34. A method comprising:
generating, for transmission to a base station, a channel measurement resource (CMR) processing capability, wherein the CMR processing capability is to indicate user equipment (UE) support for: a maximum number of transmit ports per non-zero power (NZP) channel state information (CSI)-reference signal (RS) resource for a multi-transmit-receive point (mTRP) coherent joint transmission (CJT); a maximum total number of NZP CSI-RS resources associated with the mTRP CJT; and a maximum total number of transmit ports of NZP CSI-RS resources associated with the mTRP CJT; and
outputting the CMR processing capability for transmission to a base station.

35. The method of claim 34, further comprising:
receiving a CMR configuration to configure N_{TRP} NZP CSI-reference signal (RS) resources to support the mTRP CJT, wherein N_{TRP} is an integer.

36. The method of claim 35, wherein the CMR configuration is to configure all NZP CSI-RS resources of an NZP CSI-RS resource set to be transmitted within a discontinuous reception (DRX) active time.

37. The method of claim 35, further comprising:
measuring N_{TRP} NZP CSI-RS resources;
generating (CSI) corresponding to at least some of the N_{TRP} NZP CSI-RS resources based on said measuring the N_{TRP} NZP CSI-RS resources; and
outputting, for transmission to a base station, a CSI report with the CSI.

38. The method of claim 37, further comprising:
receiving an interference measurement resource (IMR) configuration to configure one or more IMRs, the one or more IMRs to include zero power (ZP) IMRs or NZP IMRs; and
measuring the one or more IMRs; and
generating the CSI based further on measuring the one or more IMRs.

39. The method of claim 38, wherein the one or more IMRs include only one or more ZP IMRs or include only one or more NZP IMRs.

40. The method of claim 38, further comprising:
generating, for transmission to the base station, IMR processing capabilities to indicate the UE supports ZP IMR or NZP IMR.

41. The method of claim 38, wherein:
the one or more IMRs include one IMR mapped to the N_{TRP} NZP CSI-RS resources; or the one or more IMRs include the N_{TRP} IMRs respectively mapped to the N_{TRP} NZP CSI-RS resources.

42. The method of claim 35, wherein the CMR configuration includes N_{TRP} power control offsets that respectively correspond to the N_{TRP} NZP CSI-RS resources and the method further comprises:
calculating an average power control offset based on the N_{TRP} power control offsets;
determining a channel quality indicator (CQI) based on the average power control offset; and
generate the CSI to include the CQI.

43. The method of claim 35, wherein the CMR configuration includes N_{TRP} power control offsets that respectively correspond to the N_{TRP} NZP CSI-RS resources and the method further comprises:
determining a channel quality indicator (CQI) for each of the N_{TRP} NZP CSI-RS resources based on a corresponding power control offset; and
generating the CSI to include the CQIs for each of the N_{TRP} NZP CSI-RS resources.

44. One or more non-transitory, computer-readable media having instructions that, when executed, cause processor circuitry to:
generating, for transmission to a base station, a channel measurement resource (CMR) processing capability associated with a multi-transmit-receive point (mTRP) coherent joint transmission (CJT);
output the CMR processing capability for transmission to a base station; and
receive a CMR configuration to configure all NZP CSI-RS resources of an NZP CSI-RS resource set to be transmitted within a discontinuous reception (DRX) active time.

45. The one or more non-transitory, computer-readable media of claim 44, wherein the CMR processing capability is to indicate user equipment (UE) support for: a maximum number of transmit ports per non-zero power (NZP) channel state information (CSI)-reference signal (RS) resource for a multi-transmit-receive point (mTRP) coherent joint transmission (CJT); a maximum total number of NZP CSI-RS resources associated with the mTRP CJT; and a maximum total number of transmit ports of NZP CSI-RS resources associated with the mTRP CJT.
